(19) United States
(12) Patent Application Publication
(10) Pub. No.: US 2019/0327988 A1
(43) Pub. Date: Oct. 31, 2019

(54) METHOD FOR HEATING A CONCENTRATE IN AN INSTALLATION FOR SPRAY DRYING AND INSTALLATION FOR PERFORMING THE METHOD

(71) Applicant: GEA TDS GmbH, Sarstedt (DE)

(72) Inventors: Uwe Schwenzow, Ahaus (DE); Ulrich Rolle, Everswinkel (DE); Hubert Assing, Ahaus (DE); Ludger Tacke, Velen (DE); Andreas Schmied, Dülmen (DE)

(73) Assignee: GEA TDS GmbH, Sarstedt (DE)

(21) Appl. No.: 16/310,038

(22) PCT Filed: Jun. 14, 2017
(86) PCT No.: PCT/EP2017/000695

§ 371 Date: Dec. 14, 2018

(30) Foreign Application Priority Data
Jun. 23, 2016 (DE) 10 2016 007 636.4

(51) Int. Cl. A23C 1/04; A23L 3/46

(52) U.S. Cl. CPC A23C 1/04; F28D 7/16; A23L 3/46

(57) ABSTRACT

A device for heating a concentrate comprises a drying tower comprises a plurality of pressurized spray nozzles, a feed tank fluidly connected with an inlet of a low-pressure heat, a feed pump, and a high-pressure piston pump connected on an inlet side with the outlet of the low-pressure heat exchanger. A first high-pressure line section of the high-pressure line is configured to connect the outlet of the high-pressure piston pump with the inlet of the additional high-pressure heat exchanger. A second high-pressure line section of the high-pressure line is configured to connect the outlet of the additional high-pressure heat exchanger with the pressurized spray nozzles. A means for defined shear loading of the concentrate is located in an outlet-side channel and comprises an annular-shaped space.

### CROSS REFERENCE TO RELATED INVENTION

This application is a national stage application pursuant to 35 U.S.C. § 371 of International Application No. PCT/EP2017/000695, filed on Jun. 14, 2017, which claims priority to, and benefit of, German Patent Application No. 10 2016 007 636.4, filed Jun. 23, 2016, the entire contents of which are hereby incorporated by reference.

### BACKGROUND

The invention relates to a method for heating a concentrate in an installation for spray drying, in particular for temperature-sensitive concentrates, and an installation for performing the method. The invention further relates to a method for controlling the heating of a concentrate in an installation for spray drying. Temperature-sensitive concentrates should be understood in particular as substrates that have a high concentration of proteins and dry material and little water, which are easily denatured and which are processed into a sterile final product during the course of the spray drying under aseptic conditions.

The production of powdered food products, in particular milk products, such as easily soluble food products for small children, takes place in many cases by spray drying in a so-called drying tower. There, a product previously concentrated to a certain concentration of dry substance in a vaporizer or respectively an evaporator and then heated to a defined temperature in a heater, hereinafter referred to as the concentrate, is sprayed into a hot air flow either via disks or, as in the below preferred case, via nozzles, in particular single product nozzles. The concentrate leaving the heater is supplied to these so-called pressurized spray nozzles by means of a high-pressure piston pump, a so-called nozzle pump, with a pressure which can reach up to max. 350 bar.

The statics of the drying towers is generally insufficient for supporting the heavy high-pressure piston pump and for installing it in the immediate vicinity of the pressurized spray nozzles, which would be desirable for technical and procedural reasons. A high-pressure piston pump arranged in the vicinity of the pressurized spray nozzles would work in this area, the so-called hot area in the head space of the drying tower, at ambient temperatures, which can reach 75 to 80° C., and require an aseptic method of operation. Moreover, a further thermal inactivation of microorganisms would not be possible.

For the aforementioned reasons, the high-pressure piston pump has been arranged up to now in the lower area of the drying tower. A significant height difference between the high-pressure piston pump and the pressurized spray nozzles is bridged via a riser, which also functions according to plan or perforce as a heat-retaining section.

In order to ensure the longest possible and most hygienic storage of the powdered food product, the final product must have a good solubility and must be as sterile as possible. The required sterility results from the killing of microorganisms mainly for the concentrate leaving the heater if it is conveyed with a suitable temperature and dwell time progression and if the riser functioning as the heat-retaining section to the pressurized spray nozzles is taken into account. The production of so-called “low heat powder” requires a temperature of max. 77° C., so-called “high heat powder” requires approx. 85° C. and so-called “ultra high heat powder” requires up to 125° C.

The necessary average dwell time of the concentrate in the riser after the previous high-pressure treatment in connection with a hot temperature impacts the solubility of the final product in an undesired manner. Moreover, the long heat retention in the riser leads to a denaturing of the concentrate. Thus, for example, the average dwell time of the concentrate is 42 seconds if it is conveyed in a 30-meter-long riser with a diameter of DN50 and with a volumetric flow of 5,000 liters/hour. This also generally means a quality reduction of the final product. This type of denaturing can for example impact the powder quality of baby food such that its full solubility is no longer guaranteed and an unacceptable clump formation occurs in the prepared baby food. Moreover, the long dwell time at high temperatures leads to chemical reactions in the concentrate and to the formation of deposits, so-called product fouling, on the walls of the riser and in the pressurized spray nozzles, whereby the production time for a provided charge concentrate is undesirably extended.

For example, for milk concentrates, the temperature in the riser and thus up to the pressurized spray nozzles must not be higher than 65 to 68° C. in order to avoid crystallization processes in the lactose. The long riser thus restricts the permissible temperature there.

An improvement of the microbacterial status of the concentrate before the evaporator, for example through sterilization by means of microfiltration, is known. It is complex but improves the microbacterial status of the final product.

The necessary sterility up to the inlet of the pressurized spray nozzles can also be threatened by the high-pressure piston pump, since it cannot convey the concentrate with justifiable technical effort under aseptic conditions. Aseptic conveyance conditions require in contrast considerable technical effort, which in practice is generally not operated or cannot be operated. Germs from the ambient air can be introduced into the concentrate via the pistons of the high-pressure piston pump so that a reinfection takes place there. The powdered final product can then be contaminated and the contamination will increase depending on time through the effect of the residual moisture notoriously remaining in the final product.

According to the prior art, an aseptic conveyance of the liquid base product leaving the heater is only possible with increased technical effort in the downstream high-pressure piston pump.

The known installations for spray drying, in which a low-pressure heating and subsequent pressure increase in the foot area of the drying tower takes place to a maximum of 350 bar and a conveyance of the concentrate takes place via a riser up to the pressurized spray nozzles, have the following disadvantages:
the riser acts like a technologically undesired dwell time section and a heat retainer;
the dwell time necessarily reduces the inlet temperature into the pressurized spray nozzles;
the dwell time results in an undesired viscosity increase (gelatinization effect);
the state of the temperature-sensitive concentrate before the pressurized spray nozzles is not clearly defined, because the dwell time in the riser cannot be clearly defined;
the dwell time in connection with the heat retention leads to the denaturing of the concentrate, which involves increased concentrate deposits;
this results in a shorter service life of the installation, which must thus be cleaned more frequently;
the high-pressure piston pump would need to operate in a sterile manner, i.e. the concentrate must be treated aseptically by the pump, which is associated with high costs;
high-pressure piston pumps, which do not operate aseptically, lead to a heavily contaminated final product;
a reduced output of the drying tower results due to the relatively low temperature in front of the pressurized spray nozzles.

In order to achieve the necessary sterility of the liquid concentrate leaving the high-pressure piston pump under a high pressure, a suitable high-pressure heating of the concentrate en route to the pressurized spray nozzles could be provided. This high-pressure heating could take place directly in front of the pressurized spray nozzles, whereby the temperature in the riser could be reduced to a non-critical level. This arrangement would also continue to allow for the operation of a non-aseptically conveying high-pressure piston pump at the foot of the drying tower. In this connection, it was already suggested to perform the high-pressure heating in a sufficiently pressure-resistant, coiled monotube, which is supplied with steam from outside for heating. However, this suggestion is not advantageous, since a uniform heat input via the outside and over the entire length of the monotube and thus an even dwell time for all particles of the concentrate flowing in the monotube is not ensured.

A heat exchanger designed as a monotube is also known from U.S. Pat. No. 3,072,486 A. This publication describes the preparation of soluble milk powder in an installation for spray drying. A concentrate of skim milk or whole milk is preheated in a heating apparatus to a temperature between approximately 40° C. and 49° C., subsequently supplied to a mixer by means of a displacement pump, and then foamed there into a stable foam by supplying a gas. The foam is discharged from the mixer via a pipeline, is supplied to a high-pressure pump, undergoes a pressure increase there to for example approximately 103 bar and exits into a spray dryer at a spray head, which is connected with the high-pressure pump via the pipeline. An end section of the pipeline discharging into the spray head is surrounded by a tube with a larger diameter, which supplies gas heated in an oven to a temperature of approximately 232° C. to the spray head with a temperature between approximately 82° C. and 84° C. The end section of the pipeline transporting the foam thus represents a monotube heated from the outside with a gas.

A heat exchanger, which fulfills the requirements for a sufficiently uniform heat input and for an almost equal dwell time for all particles of the concentrate at a low pressure level, would generally be a so-called shell-and-tube heat exchanger, which could in principle take the place of the aforementioned monotube. The basic structure of this type of shell-and-tube heat exchanger is described for example in DE 94 03 913 U1. DE 10 2005 059 463 A1 also discloses this type of shell-and-tube heat exchanger for a low pressure level and also shows how a number of tube bundles can be arranged parallel in this heat exchanger and connected in series in a fluid-accessible manner by means of connecting fittings or connecting fittings. FIG. 1 in this document shows this type of arrangement (prior art).

Although in the interim a bend or respectively a connecting fitting for product pressures up to 350 bar for connecting the tube bundle in this type of shell-and-tube heat exchanger is available (DE 10 2014 012 279 A1), wherein the known shell-and-tube heat exchanger (DE 94 03 913 U1; DE 10 2005 059 463 A1) is not suitable for this high pressure level, the procedural problem is also not solved, which consists of treating a concentrate for spray drying in front of the pressurized spray nozzles, in which a denaturing of the concentrate and product deposits are avoided and a sterile, i.e. microbiologically perfect final product is guaranteed.

The object of the present invention is thus to overcome the disadvantages of the prior art and to provide a method for heating a concentrate in an installation for spray drying of the generic type and an installation for performing the method, which reduce the tendency toward the denaturing of the concentrate and toward deposits of the same in the case of an economical increase in the output of the drying tower, while ensuring a microbiologically perfect final product.

### BRIEF SUMMARY OF THE INVENTION

This object is solved by a method with the characteristics of claim 1. Advantageous designs of the method are the subject matter of the dependent claims. An installation for performing the method is specified with the characteristics of claim 8. Advantageous designs of the installations according to the invention are the subject matter of the associated dependent claims. A method for controlling the heating of a concentrate in an installation for spray drying is the subject matter of claim 7.

The method according to the invention emanates from the known method,
in which, at a low pressure level, a low-pressure heating of the concentrate from a flow temperature to an inlet temperature required for a pressurized spraying of the concentrate, which also represents the spraying temperature, is performed and
in which a pressure increase of the concentrate to a high pressure level subsequently takes place.

The method is particularly suitable for the retrofitting of an existing installation, in which an aseptically functioning or a non-aseptically functioning high-pressure piston pump is arranged, and it is characterized by the sequence of the following steps (a) to (c):
(a) additional high-pressure heating (H2) of the concentrate (K) at the high pressure level (p2) to an elevated spraying temperature (T3), which lies in the range of 75 to 80° C., by means of a high-pressure heat exchanger (16), which is supplied on the secondary side with a heat-transfer medium (W) and which is configured as a shell-and-tube heat exchanger having a plurality of inner tubes, through which the concentrate (K) flows in parallel and which are arranged in the shape of a circular ring and on a single circle and which together form an inner channel,
(b) defined shear loading (S) of the concentrate (K) in the course of or immediately after the treatment according to step (a) with means that consists of an outlet-side channel having the shape of an annular space, which channel adjoins the inner channel in the flow direction and has a defined extension length and a defined length-dependent progression of its channel passage cross-sections, and
(c) subsequent immediate transfer (Ü) of the concentrate (K) treated according to step (b) to the location of its pressurized spraying (DZ), wherein a transfer time (Δt) for the immediate transfer (Ü) is determined by a minimum possible fluidic effective distance between the means for performing the step (b) and the location of the pressurized spraying (DZ).

In the case of the method, the heating of the concentrate to the elevated spraying temperature takes place in two steps and namely with a pressure increasing from a low pressure level to a high pressure level between the two steps.

In the method, an important inventive fundamental idea consists in that the concentrate is subjected to a defined shear loading in the course of the additional high-pressure heating or immediately after the additional high-pressure heating to the elevated spraying temperature. A defined shear loading shall be understood as a flow-mechanical loading of the concentrate, which exerts shear forces on the concentrate. These shear forces are determined by a defined extension length and a defined length-dependent progression of the channel passage cross-section of an outlet-side channel having the shape of an annular space, through which the concentrate must flow, and they can be adjusted for the respective requirements of the concentrate (formulation) through the geometric design of this channel.

This is followed by an immediate transfer of the concentrate to the location of its pressurized spraying. The transfer time for this immediate transfer is set up to be as short as possible. Specifically, as short as possible means that the means for the additional high-pressure heating, which preferably includes the means for shear loading, receives a minimum possible fluidic effective distance to the location of the pressurized spraying, the pressurized spray nozzles. The means for shear loading preferably flow directly into the pressurized spray nozzles. A fluidic effective distance in this connection means the flow path actually covered by the concentrate.

With the additional high-pressure heating according to the invention, the increasingly disadvantageous heat retention up to now in the prior art is all but capped and it is possible to define the heating directly in front of the pressurized spray nozzles or respectively to set up the heat treatment in a reproducible manner. Desired heat loads, depending on and adjusted for the concentrate, can be set up in a defined manner for the mass flow and the ingredients. Moreover, a controlled denaturing of the concentrate in light of the desired final product is possible in that the temperature and dwell time are set during the additional high-pressure heating. An effective microbiological improvement of the final product or a defined protein or starch swelling is thereby achieved.

Through the lower temperature in the riser and the lower dwell time at the high temperature in the course of the additional high-pressure heating, the viscosity increase in the concentrate, the so-called gelatinization effect, caused by crystallization processes and/or product-specific properties, is lower than in known methods. This gelatinization effect tends to be reduced on one hand by the defined shear loading, and the gelatinization effect is standardized on the other hand, whereby the pressurized spray nozzles first agglutinate much later through the formation of deposits. Cleaning and setup time is thus reduced.

A further advantage of the measures according to the invention is that the concentrate can be supplied with a higher dry material concentration. A dry material increase from 55 to max. 65 mass percent is possible depending on the properties of the concentrate. Mass percent of the concentrate means the ratio in percent, formed from the mass of the concentrate contained in a mass of liquid. The performance of the pressurized spray installation or respectively the drying installation is known to increase with a higher dry material concentration, wherein the spray temperature can be increased by 1 to max. 5° C. with respect to known methods with the same powder quality.
An increase in the temperature of the concentrate leaving the pressurized spray nozzle by 1° C. results in an efficiency increase, i.e. an increase in the output of the drying tower from 2.5 to 3%

$$( \frac{( 2 , 5 - 3 ) \%}{{1}^{°} C .} ) .$$

The method according to the invention thus decreases the required specific energy for drying and existing drying capacities can be extended.
There exists the possibility of using the method according to the invention introduced here for a UHT treatment of the concentrate up to into the aseptic area with the goal of producing so-called “ultra high heat powder”.

The defined shear loading of the concentrate in the course of or immediately after the additional high-pressure heating is performed such that the concentrate flows through defined passage cross-sections with defined extension lengths with defined elevated flow speeds. For controlling the defined shear loading, one design of the method provides that an elevated flow speed of the concentrate during the additional high-pressure heating is increased by 20 to 25% in the treatment area located upstream from the additional high-pressure heating with respect to its flow speed. In this regard, it is suggested that the elevated flow speed is max. 3 m/s. Since this increase in the flow speed takes place at a high pressure level, the associated additional pressure losses during the high-pressure heating process do not play a significant role. The elevated flow speed results in a better heat transfer on the concentrate side, which results in the following further advantages:
a heat exchange with a lower heat exchanger surface area is possible;
a protein concentrate with a higher concentration is possible;
a higher volumetric flow and thus a higher output rate are possible;
due to the better heat transfer, a higher heating of the concentrate and thereby a higher drying performance are possible;
a defined, systematically desired denaturing of the concentrate takes place.

The method according to the invention provides that the high pressure level to which the concentrate is brought through pressure increasing is max. 350 bar. Furthermore, one design of the method according to the invention provides that the increased spraying temperature lies in the range of 75 to 80° C. and is preferably set here to 80° C. The method further provides a concentrate with a dry material concentration of up to max. 65 mass percent (65 m %).

The installation for performing the method, which is attached to an installation according to the prior art and further develops it in terms of the object according to the invention, generally comprises a drying tower with pressurized spray nozzles, a feed tank, which is connected in a fluid-accessible manner with the inlet of a low-pressure heat exchanger via a first line section of a low-pressure line, in which a feed pump is arranged. It further comprises of a high-pressure piston pump, which is connected on the inlet side with the outlet of the low-pressure heat exchanger via a second line section of the low-pressure line and on the output side with the pressurized spray nozzles via a high-pressure line.

It is suggested according to the invention that the high-pressure line passes over an additional high-pressure heat exchanger. The high-pressure heat exchanger is configured as a shell-and-tube heat exchanger having a plurality of inner tubes, through which the concentrate flows in parallel and which are arranged in the shape of a circular ring and on a single circle and which together form an inner channel. The inner channel adjoins the inner tube in the shape of a circumferential annular space in the flow direction. A first high-pressure line section of the high-pressure line thereby connects the outlet of the high-pressure piston pump with the inlet of the additional high-pressure heat exchanger, and a second high-pressure line section of the high-pressure line connects the outlet of the additional high-pressure heat exchanger with the pressurized spray nozzles.

A fluidic effective length of the second high-pressure line section is thereby reduced to a structurally feasible minimum size, i.e. the outlet of the additional high-pressure heat exchanger is brought as close as structurally possible to the pressurized spray nozzles, with respect to the flow path of the concentrate.

The additional high-pressure heat exchanger has means on the outlet side for the defined shear loading of the conveyed concentrate, wherein this means is effective without moving elements and/or the supply of external energy in a purely fluidic manner through defined passage cross-sections, defined lengths of the flow paths and defined elevated flow speeds.

The means for the defined shear loading of the concentrate exists in an, outlet-side channel having the shape of an annular space, which is connected on one side with the outlet of the circumferential annular space and on the other side with the second high-pressure line section. The annular-space-shaped, outlet-side channel thereby has in the most general scenario a defined extension length and a defined extension-length-dependent progression of its channel passage cross-sections.

The characteristic with respect to the arrangement of a plurality of inner tubes that are flowed through in parallel should be understood as an arrangement, which, independent of the number of inner tubes, does not occupy an entire circular cross-section of a shell-and-tube heat exchanger. Rather, all inner tubes are arranged on the said single circle, which leaves unoccupied an inner area, not only a delimited center, of inner tubes. This arrangement makes it possible that the inner channel, formed by the inner tubes arranged in the shape of a circular ring and on a single circle in the flow direction, can adjoin the inner tubes in the shape of a circumferential annular space.

In terms of a same dwell time for all parts of the heat-treated concentrate, it is thereby advantageous, as is also suggested, that the channel passage cross-sections are constant over the entire extension length. This desirable equal treatment is further promoted in that the elevated flow speed through the entire shell-and-tube heat exchanger is as uniform as possible up to the end of the defined shear loading of the concentrate, wherein a further embodiment in this respect provides that the channel passage cross-section corresponds with the total passage cross-section of all inner tubes that are flowed through in parallel.

The method according to the invention and the installation for performing the method can be controlled in an advantageous manner depending on the concentrate. For this, the invention suggests a method for controlling the heating of a concentrate in an installation for spray drying. The control parameters for the additional high-pressure heating are determined by the properties of the concentrate to be heated and the physical edge conditions. The properties of the concentrate to be heated are its volumetric flow, viscosity, pressure, temperature and dry material concentration and the physical edge conditions are the pressure and temperature at the location of the pressurized spraying. The control parameters, respectively relating to the concentrate, are the high pressure level, the elevated spray temperature, the elevated flow speed during the additional high-pressure heating and the intensity of the shear loading.

The control parameters are set by means of a calibration function saved or generated before or during startup of the installation for spray drying. The calibration function is obtained in that

control parameters of the discussed type are obtained during the startup and retraction of the installation with a discrete concentrate (formulation) until a satisfactory product quality is obtained,
they are registered and saved in a controller in the form of a “calibration function” (control parameters=function of (concentrate or respectively formulation)).

During a later treatment of the same concentrate (formulation), these empirical values in the form of this calibration function can be accessed and the necessary control parameters can be appropriately set.

### BRIEF DESCRIPTION OF THE DRAWINGS

A more detailed representation of the invention results from the following description and the attached figures in the drawings as well as from the claims. While the invention is realized in the various designs of a method and in the various embodiments of an installation for performing the method, a known method and, starting from this known method, a preferred design of the inventive method are shown schematically in the drawing. A preferred exemplary embodiment of an installation for performing the method with a high-pressure heat exchanger configured as a shell-and-tube heat exchanger is shown in the drawing and described below. In the figures:

FIG. 1 illustrates a schematic diagram of a method for heating a concentrate in an installation for spray drying according to the prior art;

FIG. 1a illustrates a schematic diagram of an embodiment of a method for heating a concentrate in an installation for spray drying according to the invention;

FIG. 2 illustrates a schematic representation of an installation according to the prior art for performing the method according to the prior art according to FIG. 1;

FIG. 3 illustrates a schematic representation of an installation for performing the embodiment of the method according to FIG. 1a; and

FIG. 4 illustrates a meridian section of an embodiment of an outlet-side area of a high-pressure heat exchanger configured as a shell-and-tube heat exchanger.

### DETAILED DESCRIPTION OF THE INVENTION

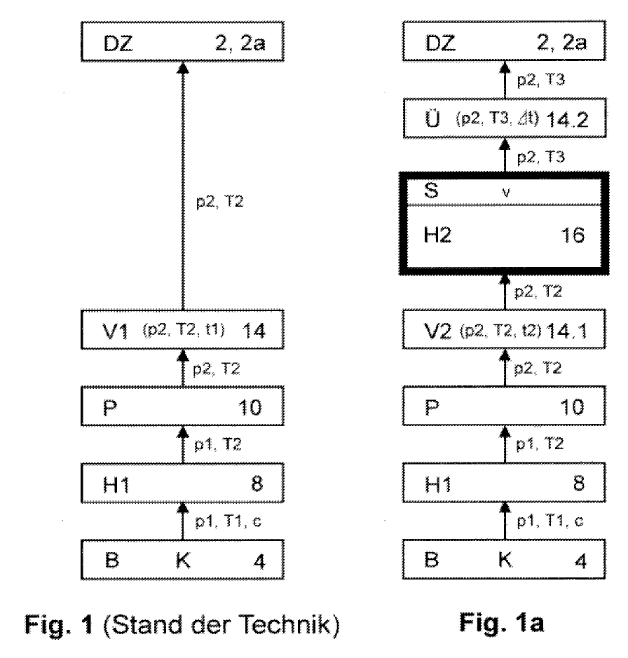

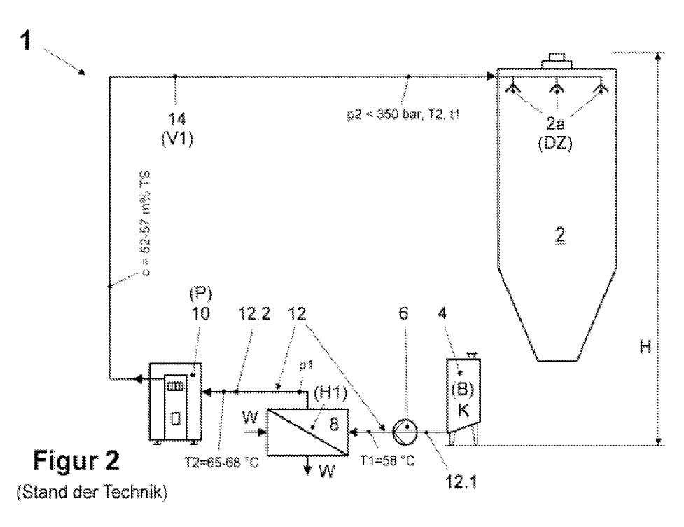

### Prior Art (FIGS. 1 and 2)

FIG. 1 shows a method for heating a concentrate K in an installation for spray drying 1 (drying installation) according to the prior art, and FIG. 2 shows an installation 1 according to the prior art for performing the known method. Below, the method and the associated installation 1 are covered in parallel based on these two figures. The named temperatures, pressures and the dry material concentration are selected as examples and can deviate upwards or downwards in practice.

The concentrate K sprayed in a drying tower 2 of the drying installation 1 by a pressurized spraying DZ via pressurized spray nozzles 2a undergoes a stockpiling B in a feed tank 4 (FIGS. 1, 2). The feed tank 4 is connected in a fluid accessible manner via a first line section 12.1 of a low-pressure line 12, in which a feed pump 6 is arranged, with the primary-side inlet of a low-pressure heat exchanger 8, in which a low-pressure heating H1 of the concentrate K from a flow temperature T1=58° C. to an inlet temperature T2=65 to 68° C., which is also still approximately present at the pressurized spray nozzles 2a, is performed. The low-pressure heat exchanger 8 is supplied on the secondary side by means of a heat-transfer medium W, preferably hot water. A high-pressure piston pump 10 is connected on the inlet side via a second line section 12.2 of the low-pressure line 12 with the primary-side outlet of the low-pressure heat exchanger 8 and on the outlet side via a high-pressure line 14 with the pressurized spray nozzles 2a.

In the high-pressure piston pump 10, a pressure increasing P of the concentrate K from a low pressure level p1 present on the inlet side to a high pressure level p2 generated on the output side, which can reach up to p2=max. 350 bar and with which the pressurized spray nozzles 2a are operated minus the drop in pressure up to the latter, takes place. The concentrate K has a dry material concentration c, which can be for example 52 to 57 mass percent (m %) dry material TS.

The drying tower 2 has a tower height H up to into its head area, in which the pressurized spray nozzles 2a are arranged. The high-pressure line 14 mainly overcomes this tower height H in the form of a riser. In the case of a tower height for example of H=30 m, the high-pressure line 14 is also at least 30 m long due to the connection lines located upstream and downstream of the riser. In the case of a diameter DN50 of the high-pressure line 14, a volumetric flow for example of 5,000 liters/hour for a first dwell period V1 of the concentrate K with the inlet temperature T2 at the high pressure level p2 and with the dry material concentration c results in an average first dwell time t1 of 42 seconds. The problems associated with the described method according to the prior art were covered above.

### Method and Drying Installation (FIGS. 1a, 3 and 4)

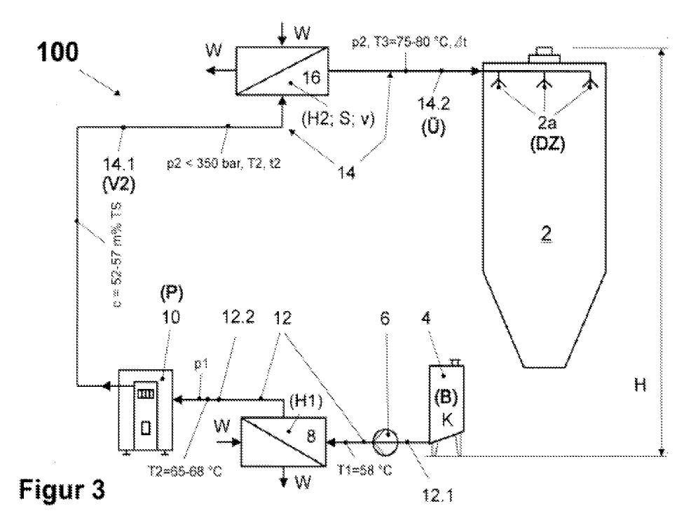

FIG. 1a shows a method according to the invention for heating a concentrate K in an installation for spray drying 100, and FIG. 3 shows an installation 100 according to the invention for performing this method. Below, the method and the associated installation are covered in parallel based on these two figures. The named temperatures, pressures and the dry material concentration are selected as examples and can deviate upwards or downwards in practice.

As shown by a comparison of FIG. 1 with FIG. 1a and FIG. 2 with FIG. 3, the method according to the invention further develops the method according to the prior art described above and the known installation 1 for performing the method. In instances where they match, the same references were used. Thus, in order to avoid repetitions, the above description for FIGS. 1 and 2 are referenced.

FIG. 1a obviously shows through thicker lines the differences between the method according to the prior art (FIG. 1) and the method according to the invention, and FIG. 3 shows, based on the drying installation 100, how these differences are realized in terms of the device.

The high-pressure line 14 (FIG. 3) passes over the primary side of an additional high-pressure heat exchanger 16, wherein a first high-pressure line section 14.1 of the high-pressure line 14 connects the outlet of the high-pressure piston pump 10 with the inlet of the additional high-pressure heat exchanger 16, and a second high-pressure line section 14.2 of the high-pressure line 14 connects the outlet of the additional high-pressure heat exchanger 16 with the pressurized spray nozzles 2a. The additional high-pressure heat exchanger 16 is supplied on the secondary side with a heat-transfer medium W, preferably hot water. The values selected as examples in FIG. 3 for the low pressure level p1, the high pressure level p2, the flow temperature T1, the inlet temperature T2 up to the additional high-pressure heater 16 and the dry material concentration c mainly correspond with those values named in methods according to the prior art and the installation 1 for performing the method (see FIGS. 1, 2).

In the additional high-pressure heat exchanger 16, an additional high-pressure heating H2 of the concentrate K at the high pressure level p2 to an elevated spraying temperature T3, which can lie in the range of 75 to 80° C., takes place (FIG. 3). Furthermore, a defined shear loading S of the concentrate K is provided in the course of or immediately after the additional high-pressure heating H2 at an elevated flow speed v (FIGS. 3, 1a). For this, the additional high-pressure heat exchanger 16 has means on the outlet side for the defined shear loading of the conveyed concentrate K.

Since the additional high-pressure heat exchanger 16 is arranged at the tower height H (FIG. 3), a second dwell period V2 of the concentrate K with the inlet temperature T2 at the high pressure level p2 and with the dry material concentration c with an average second dwell time t2, which is less than the first dwell time t1 and in the case of otherwise almost identical process data is thus less critical, from now on results in the riser between the latter and the outlet of the high-pressure piston pump 10, i.e. in the first high-pressure line section 14.1.

An immediate transfer Ü of the concentrate K treated by defined shear loading S is subsequently performed at the location of its pressurized spraying DZ (FIG. 1a), wherein a transfer time Δt for the immediate transfer Ü is determined by a minimum possible fluidic effective distance between the means for performing the defined shear loading S and the location of the pressurized spraying DZ. The immediate transfer Ü takes place in the correspondingly measured second high-pressure line section 14.2, which is reduced to a structurally feasible minimum size (FIG. 3).

A critical advantage results compared to the method according to the prior art among other things in that, in the case of the method according to the invention, the concentrate K is supplied to the pressurized spray nozzles 2a with a higher spray temperature, namely the elevated spray temperature T3=75-80° C., by the additional high-pressure heating H2, whereby an increase in the output of the drying tower 2 is achieved without quality losses.

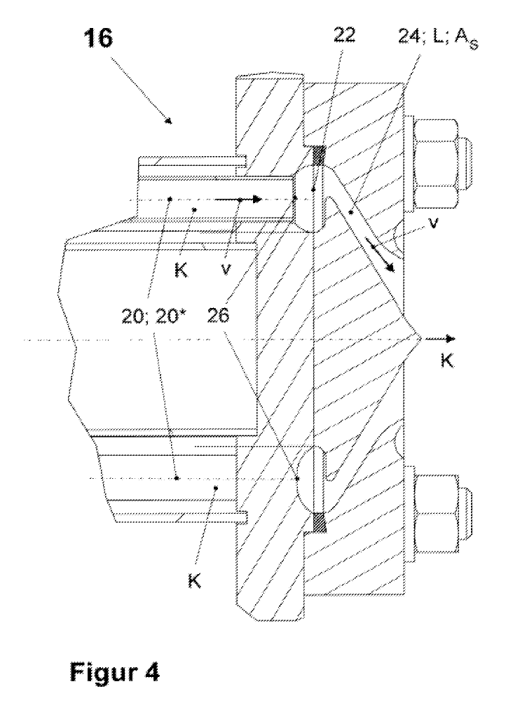

The additional high-pressure heat exchanger 16 is configured as a shell-and-tube heat exchanger with a plurality of inner tubes 20, through which the concentrate K flows in parallel (FIG. 4). The inner tubes 20 are arranged in the shape of a circular ring and on a single circle 26 and together form an inner channel 20*, which adjoins to the inner tubes (20) in the shape of a circumferential annular space (22) in the flow direction. The means for the defined shear loading of the conveyed concentrate K is arranged on the outlet side on the shell-and-tube heat exchanger 16 and consist of an outlet-side channel 24 having an annular shape, which is connected on one side with the outlet of the circumferential annular space 22 and on the other side with the second high-pressure line section 14.2. The annular-space-shaped, outlet-side channel 24 has a defined extension length L and a defined length-dependent progression of its channel passage cross-sections Aₛ and, just like the inner tubes 20, is also flowed through by the concentrate K with an elevated flow speed v.

### REFERENCE LIST OF USED ABBREVIATIONS

### FIGS. 1, 2 (Prior Art)

1 Drying installation (installation for spray drying)
2 Drying tower
2a Pressurized spray nozzle
4 Feed tank
6 Feed pump
8 Low-pressure heat exchanger
10 High-pressure piston pump (homogenizer)
12 Low-pressure line
12.1 First line section
12.2 Second line section
14 High-pressure line
H Tower height
c Dry material concentration (in mass percent (m %) dry material (TS))
t1 First dwell time

### Temperatures

T1 Flow temperature (approx. 58° C.)
T2 Inlet temperature (approx. 65-68° C.)

### Pressures

p1 Low pressure level
p2 High pressure level (<350 bar)

### Substances

K Concentrate (product)
TS Dry material
W Heat-transfer medium

### Method Steps

B Stockpiling
DZ Pressurized spraying
H1 Low-pressure heating
P Pressure increasing
V1 First dwell period

### FIGS. 1a, 3, 4 (Invention)

100 Drying installation (installation for spray drying)
14.1 First high-pressure line section
14.2 Second high-pressure line section
16 Additional high-pressure heat exchanger (shell-and-tube heat exchanger)
20 Inner tube
20* Inner channel
22 Circumferential annular space
24 Outlet-side channel having an annular-shaped space
26 Circle
Aₛ Channel passage cross-section
L Extension length
t2 Second dwell time
Δt Transfer time
v Elevated flow speed (at H2)

### Temperature

T3 Elevated spraying temperature (75-80° C.)

### Method Steps

H2 Additional high-pressure heating
S Shear loading
Ü Immediate transfer
V2 Second dwell period

1-10. (canceled)

11. A method for heating a concentrate (K) in an installation for spray drying, the method comprising:
(a) low pressure heating (H1) the concentrate (K) under a low pressure (p1) from a flow temperature (T1) to a spraying temperature (T2);
(b) increasing a pressure (P) of the concentrate (K) to a high pressure level (p2);
(c) high-pressure heating (H2) the concentrate (K) at the high pressure level (p2) to an elevated spraying temperature (T3), which lies in the range of 75 to 80° C., wherein the high pressure heating is performed via an additional high-pressure heat exchanger supplied on a secondary side with a heat-transfer medium (W) and which is configured as a shell-and-tube heat exchanger having a plurality of inner tubes configured to conduct a parallel flow of the concentrate (K), and wherein the plurality of inner tubes are arranged in a circular ring and on a single circle and which together form an inner channel, configured to adjoin the plurality of inner tubes in a shape of a circumferential annular space in the flow direction;
(d) defining a shear loading (S) of the concentrate (K) in during or immediately after the treatment according to step (c), wherein a means for shear loading comprises a channel comprising a shape of an annular space which is connected on one side with an outlet of a circumferential annular space and on another side with a second high-pressure line section, the second high-pressure line comprises a defined extension length and a defined length-dependent progression of its channel passage cross-sections; and
(e) immediately transferring (Ü) the concentrate (K) treated to a location of pressurized spraying (DZ), wherein a transfer time (Δt) for the immediate transfer (Ü) is determined by a minimum possible fluidic effective distance between a location of the pressure (P) increase of the concentrate (K) to the high pressure level (P2) and the location of the pressurized spraying (DZ).

12. The method according to claim 11, wherein the flow speed (v) of the concentrate (K) during the additional high-pressure heating (H2) is increased by 20 to 25% in a treatment area located upstream from the additional high-pressure heating (H2).

13. The method according to claim 12, wherein the flow speed (v) during the additional high-pressure heating (H2) is a maximum of 3 m/s.

14. The method according to claim 11, wherein the high pressure level (p2) is a maximum of 350 bar.

15. The method according to claim 11, wherein the elevated spraying temperature (T3) is set to 80° C.

16. The method according to claim 12, wherein the concentrate (K) is treated with a dry material concentration (c) of up to maximum of 65% mass percent (65 m %).

17. The method according to claim 11, further comprising determining control parameters for the additional high-pressure heating (H2) by properties of the concentrate (K) to be heated and physical edge conditions, wherein the properties of the concentrate (K) to be heated are its volumetric flow, viscosity, pressure, temperature and dry material concentration, wherein the physical edge conditions are the pressure and temperature at the location of the pressurized spraying (DZ), wherein the control parameters of the concentrate (K) are the high pressure level (p2), the spray temperature (T3), the flow speed (v) during the additional high-pressure heating (H2) and intensity of the shear loading (S), and wherein the control parameters are set by a calibration function.

18. A device for heating a concentrate, the device comprising:
a drying tower comprising a plurality of pressurized spray nozzles,
a feed tank fluidly connected with an inlet of a low-pressure heat exchanger via a first line section of a low-pressure line,
a feed pump positioned in the along the first line section of the low pressure line, and
a high-pressure piston pump connected on an inlet side with the outlet of the low-pressure heat exchanger via a second line section of the low-pressure line and connected on the outlet side with the pressurized spray nozzles via a high-pressure line, wherein the high-pressure line is guided via an additional high-pressure heat exchanger configured as a shell-and-tube heat exchanger having a plurality of inner tubes, through which the concentrate (K) flows in parallel and which are arranged in the shape of a circular ring and on a single circle which together form an inner channel that adjoins the inner tubes in the flow direction in the shape of a circumferential annular space;
a first high-pressure line section of the high-pressure line is configured to connect the outlet of the high-pressure piston pump with the inlet of the additional high-pressure heat exchanger;
a second high-pressure line section of the high-pressure line is configured to connect the outlet of the additional high-pressure heat exchanger with the pressurized spray nozzles;
a fluidic effective length of the second high-pressure line section is reduced to a structurally feasible minimum size, and
a means on the outlet side for defined shear loading of the concentrate (K) located in an outlet-side channel and comprising an annular-shaped space, which is connected on one side with the outlet of the circumferential annular space and on the other side with the second high-pressure line section, wherein the outlet-side channel has a defined extension length (L) and a defined length-dependent progression of its channel passage cross-sections (Aₛ).

19. The device according to claim 18, wherein the channel passage cross-sections (Aₛ) are constant over the defined extension length (L).

20. The device according to claim 19, wherein the channel passage cross-sections (Aₛ) correspond with a total passage cross-section of all inner tubes that are flowed through in parallel.
